(19) United States
(12) Patent Application Publication
(10) Pub. No.: US 2013/0066984 A1
(43) Pub. Date: Mar. 14, 2013

(54) APPARATUS AND METHOD FOR MANAGING BROADCAST MESSAGE GROUP

(71) Applicant: Chi Sun SHIN, Seoul (KR)

(72) Inventor: Chi Sun SHIN, Seoul (KR)

(73) Assignee: PANTECH CO., LTD., Seoul (KR)

(21) Appl. No.: 13/607,058

(22) Filed: Sep. 7, 2012

(30) Foreign Application Priority Data
Sep. 9, 2011 (KR) 10-2011-0091703

(51) Int. Cl. G06F 15/16

(52) U.S. Cl. 709/206

(57) ABSTRACT

A method for managing a broadcast message group includes storing a broadcast message and multiple messages associated with the broadcast message, classifying the multiple messages into multiple message subgroups, generating the broadcast message group including the broadcast message and the multiple message subgroups, and displaying the broadcast message and the multiple message subgroups if the broadcast message group is selected. An apparatus includes a storage unit to store a broadcast message and a reply message associated with the broadcast message, a display unit to display a broadcast message group in a message list, a controller to generate the broadcast message group including the broadcast message and the reply message. The display unit displays the broadcast message and the reply message if the broadcast message is selected.

### CROSS-REFERENCE TO RELATED APPLICATION

This application claims priority from and the benefit under 35 U.S.C. §119(a) of Korean Patent Application No. 10-2011-0091703, filed on Sep. 9, 2011, which is incorporated herein by reference for all purposes as if fully set forth herein.

### BACKGROUND

1. Field

The following description relates to an apparatus and method for managing a broadcast message group, and more particularly to an apparatus and method for managing and indicating a broadcast message group including a broadcast message and associated messages.

2. Discussion of the Background

The spread of various kinds of communication devices, such as cellular phones, personal tablet computers, or the like, has been increasingly vast, and many communication devices provide functions of transmitting and receiving electronic messages, such as e-mails, text messages, and the like. Further, due to universal utilization of the electronic message communications among communication devices, more convenient electronic message functions have been introduced. For example, a broadcast message enables a user to transmit the same message to multiple recipients without repeated message generation processes. However, if a communication device displays a messaging history between a user of the communication device and another user of a counterpart communication device by displaying transmitted messages and received messages in a list form, it may be difficult for the user to check one-on-one message communications by recipients in a broadcast message communication. If a user transmits a message, i.e., a broadcast message, to multiple recipients using a communication device and receives reply messages from the multiple recipients, it may be difficult to check reply messages from the multiple recipients efficiently in a display screen. In particular, when reply messages to the broadcast message are received and mingled with other non-broadcast messages, it may cause inconvenience for the user to check each reply message.

### SUMMARY

Exemplary embodiments of the present invention provide an apparatus and method for managing and indicating a broadcast message group including a broadcast message and associated messages. The apparatus and method may arrange the broadcast messages to increase the visibility of communicated messages in a display of an apparatus, such as a mobile communication terminal.

Exemplary embodiments of the present invention also provide an apparatus and method for managing a broadcast message communication such that a broadcast message and reply messages associated with the broadcast message are grouped and indicated in a hierarchical order in a display screen, thereby increasing visibility of the messages and message search function.

Exemplary embodiments of the present invention also provide an apparatus and method for providing a broadcast message group that may include subgroups capable of being unfolded and displayed in the order of messages received according to user's option. The broadcast message group may further be grouped according to recipients of the broadcast message to enable the respective recipients and the transmitted or received broadcast messages to be separately checked.

Additional features of the invention will be set forth in part in the description which follows and, in part, will be apparent from the description, or may be learned by practice of the invention.

Exemplary embodiments of the present invention provide an apparatus to manage a broadcast message group, including: a storage unit to store a broadcast message and multiple messages associated with the broadcast message; a display unit to display the broadcast message and multiple message subgroups; and a controller to classify the multiple messages into the multiple message subgroups, and to generate the broadcast message group including the broadcast message and the multiple message subgroups.

Exemplary embodiments of the present invention provide a method for managing a broadcast message group, including: storing a broadcast message and multiple messages associated with the broadcast message; classifying the multiple messages into multiple message subgroups; generating the broadcast message group including the broadcast message and the multiple message subgroups; and displaying the broadcast message and the multiple message subgroups if the broadcast message group is selected.

Exemplary embodiments of the present invention provide an apparatus, including: a storage unit to store a broadcast message and a reply message associated with the broadcast message; a display unit to display a broadcast message group in a message list; a controller to generate the broadcast message group including the broadcast message and the reply message. The display unit displays the broadcast message and the reply message if the broadcast message is selected.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram of a communication device according to an exemplary embodiment of the present invention.

FIG. 2 is a flowchart illustrating a process of indicating a broadcast message group in a communication device according to an exemplary embodiment of the present invention.

FIG. 3A, FIG. 3B, and FIG. 3C are diagrams illustrating broadcast message reply option menu icons displayed on a broadcast message display screen in a communication device according to an exemplary embodiment of the present invention.

FIG. 4A is a diagram illustrating a message list including a broadcast message group displayed along with unicast messages in a communication device according to an exemplary embodiment of the present invention.

FIG. 4B is a diagram illustrating a selected broadcast message group including one or more transmitted broadcast messages and reply messages from multiple recipients according to an exemplary embodiment of the present invention.

FIG. 5A is a diagram illustrating a broadcast message group including subgroups arranged by recipient in a communication device according to an exemplary embodiment of the present invention.

FIG. 5B is a diagram illustrating a broadcast message group including subgroups displaying unfolded subgroup messages according to an exemplary embodiment of the present invention.

FIG. 6, FIG. 7, and FIG. 8 are diagrams illustrating a method for arranging a broadcast message group in a communication device according to an exemplary embodiment of the present invention.

FIG. 9 is a diagram illustrating broadcast electronic mails grouped and arranged by recipients in a communication device according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Configurations of a communication device according to exemplary embodiments of the present invention will be described.

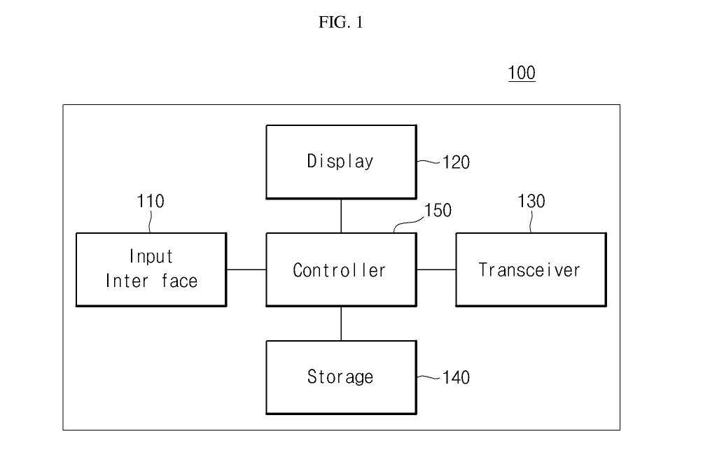

FIG. 1 is a schematic diagram of a communication device according to an exemplary embodiment of the present invention.

Referring to FIG. 1, a communication device 100 includes an input interface 110, a display 120, a transceiver 130, a storage 140 and a controller 150. The communication device 100 may transmit or receive an electronic message including a broadcast message. For example, the electronic message (“the message”) may be in the form of a text message transmitted/received between cellular phones. A multicast message may refer to a message created and transmitted to more than one recipient, and the broadcast message may refer to a message created and transmitted by a broadcasting method. Further, the broadcast message may be a message transmitted to all members included in a selected group or a message transmitted to all registered contacts in the transmitting communication device. On the other hand, a unicast message may refer to a message or a reply message sent to one recipient. Throughout the specification, the broadcast message may refer to a type of message that includes various types of messages sent to multiple recipients, such as the multicast message, and the broadcast message as described above.

The input interface 110 may receive an input from a user of the communication device 100 and generate input information including a message, a phone number, and the like. The input interface 110 may be a key pad, a voice recognition device, and the like. Further, the input interface 110 may be formed with the display 120 in the form of a touch screen. The user may input a message or a broadcast message via the input interface 110 and transmit the inputted message to one or more recipients. If a recipient user receives the message, a reply message responding to the received message may be created via the input interface 110 of a communication device of the recipient user and the reply message may be transmitted.

The broadcast message may be transmitted from the communication device 100 to one or more communication devices. A communication device receiving the broadcast message may be the same with or different from the communication device transmitting the broadcast message.

The display 120 may be connected to the input interface 110. The display 120 may display a message according to an input inputted to the input interface 110 or a message received through the transceiver 130. If the message is a message to be transmitted, the display 120 may display the created message together with recipient information and a menu to determine whether the created message is a broadcast message. If the message is a received message, the display 120 may display the received message together with sender information and a menu to indicate whether the received message is a reply message to the broadcast message.

In addition, the display 120 may display the broadcast message and the reply messages thereto grouped and arranged under the control of the controller 150. The controller 150 may manage the broadcast message and the reply messages in a group, thereby facilitating management of broadcast messages and search of transmission and reception histories. The process of indicating the grouped broadcast message on the display 120 will be described in more detail.

The transceiver 130 may be connected to the display 120. The transceiver 130 may perform wired or wireless communication with a base station or other communication devices. Messages may be created according to an input inputted to the input interface 110 and may be transmitted to another communication device through the transceiver 130. The message received from another communication device may be displayed on the display 120.

The storage 140 may be connected to the input interface 110, the display 120 and the transceiver 130. If a broadcast message or a reply message to the broadcast message is transmitted or received, the storage 140 stores the broadcast message and the reply messages. The stored messages in the storage 140 may be grouped and arranged by the controller 150 and displayed on the display 120 by groups.

The controller 150 may be connected to the input interface 110, the display 120, the transceiver 130, and the storage 140. The controller 150 may group and arrange stored messages including the broadcast message received from the transceiver 130 or the reply message to the broadcast message.

The controller 150 may determine whether the message is a broadcast message or a unicast message using an identifier included in a data packet of the message. For example, the message may include a separate identifier indicating whether the message is a broadcast message in a User Data Field of the data packet of the message. Further, a reply message to the broadcast message may include an identifier included in a data packet of the reply message to indicate whether the reply message is a reply message to a broadcast message or to a unicast message. If it is determined by the identifier that the message is a broadcast message or the reply message is a reply message to the broadcast message, the controller 150 controls a menu to be indicated on the display 120. The menu may provide a user with a selection option to reply to the broadcast message or not to be indicated on the display 120. Further, if it is determined by the identifier that the message is a broadcast message or the reply message is a reply message to the broadcast message, the controller 150 sorts and groups the message and indicates the message on the display 120.

Further, the controller 150 may indicate broadcast message group including a broadcast message and corresponding replies together with other unicast messages on a single display screen. However, the broadcast message and corresponding replies may not be displayed but a piece of information of the broadcast message group may be displayed to represent the broadcast message group having a grouped message thread. Since the broadcast message group is distinguished from unicast messages, the user may identify the broadcast message group from unicast messages. If the broadcast message group is selected, the broadcast message and the reply messages may be displayed on a display 120 and be checked at a glance by the user. The messages in the broadcast message group may be arranged and indicated in a determined order of the messages in the broadcast message group. For example, the messages in the broadcast message group may be arranged and indicated in the order of transmission or reception time of the broadcast message and the reply messages. Further, the messages in the broadcast message group may be arranged and indicated by recipient. Therefore, the messages may be displayed based on one or more sorting criteria.

Hereinafter, a process of indicating a broadcast message group in a communication device will be described in more detail.

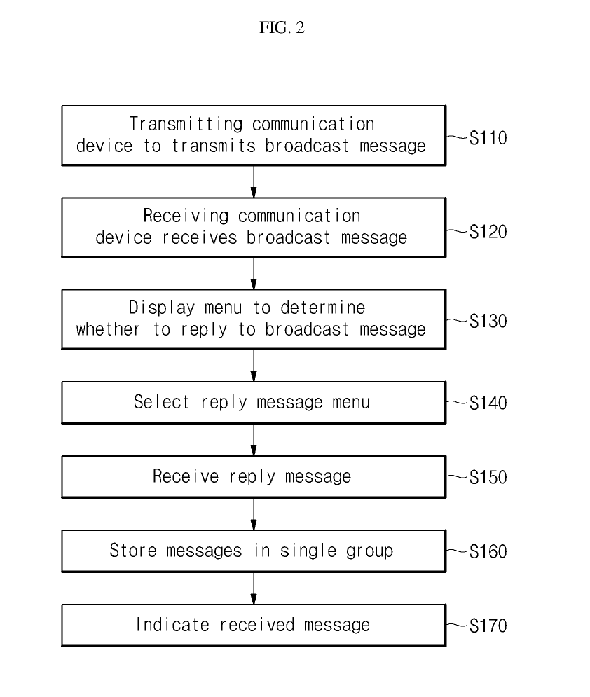

FIG. 2 is a flowchart illustrating a process of indicating a broadcast message group in a communication device according to an exemplary embodiment of the present invention.

Referring to FIG. 2, a transmitting communication device may transmit a broadcast message in operation S110. The broadcast message may be input via an input interface in the transmitting communication device and be transmitted to a receiving communication device using a transceiver.

A receiving communication device may receive the broadcast message through a transceiver in operation S120.

The receiving communication device may display the broadcast message on a display of the receiving communication device. A menu to determine whether to reply to the received broadcast message may also be indicated on the display in operation S130. For example, the menu to determine whether to reply to the received broadcast message may be displayed at one side of the display.

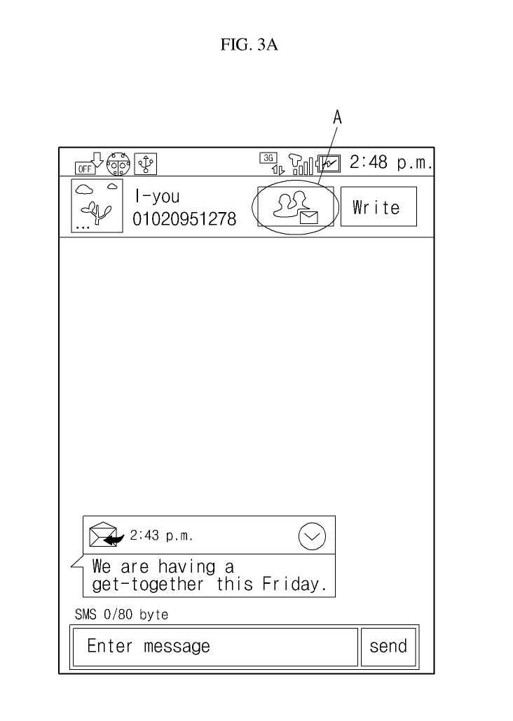

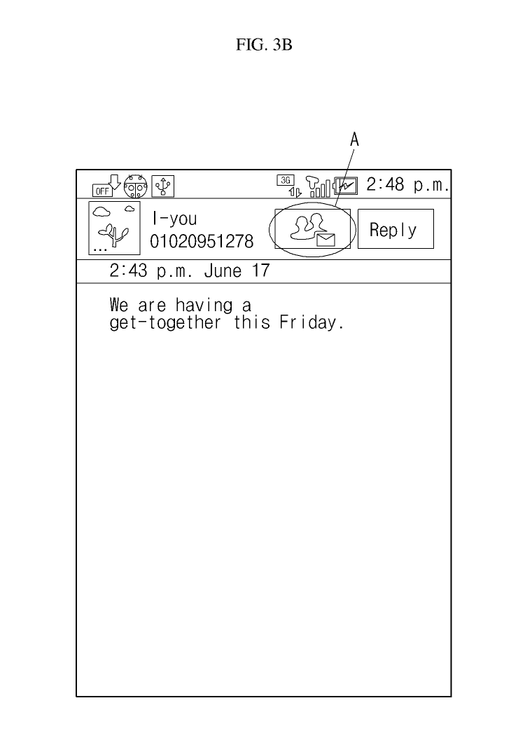

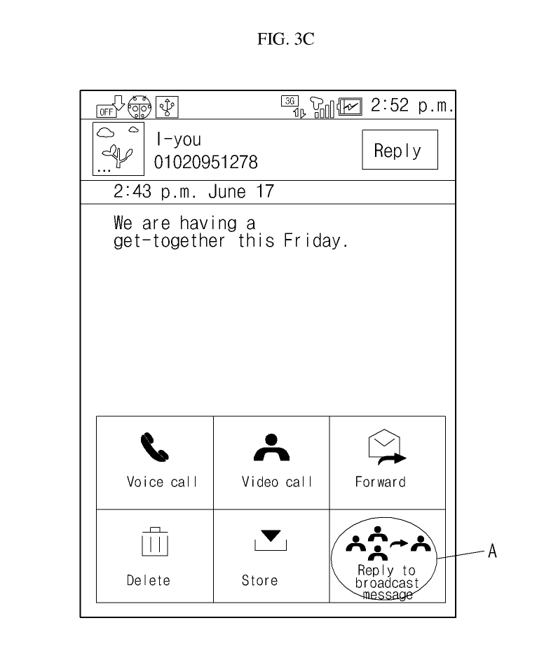

FIG. 3A, FIG. 3B, and FIG. 3C are diagrams illustrating broadcast message reply option menu icons displayed on a broadcast message display screen in a communication device according to an exemplary embodiment of the present invention.

Referring to FIG. 3A, FIG. 3B, and FIG. 3C, broadcast message reply option menu boxes may be indicated on a broadcast message display screen in the communication device. An icon A for preparing a reply message to the broadcast message may be displayed on a region of the broadcast message display screen. Hereinafter, various examples of icons A illustrated in FIG. 3A, FIG. 3B, and FIG. 3C may be referred to as “icon A.”

A controller of the receiving communication device identifies an identifier from a data packet of the message received by the receiving communication device and determines whether the message is a broadcast message. If the message is a broadcast message, the controller may indicate the message on the display together with the icon A for preparing a reply message to the broadcast message.

A user of the receiving communication device may select the icon A to generate a reply message to the broadcast message. If the icon A is selected, an identifier indicating that the reply message is a reply to a broadcast message is included in the data packet of the reply message.

Further, the user of the receiving communication device may transmit a message to the transmitting communication device without selecting the icon A. If the icon A is not selected, the identifier is not included in the message to the transmitting communication device.

Referring back to FIG. 2, the receiving communication device may select the icon A to generate the reply message and generate a reply message to the broadcast message and transmit the generated reply message through the transceiver in operation S140. Then, the transmitting communication device and/or another communication device receive the reply message in operation S150.

The broadcast message transmitted by the transmitting communication device and the reply message received by the transmitting communication device may be grouped and stored in a broadcast message group in operation S160. The broadcast message and the reply messages thereto may be grouped and stored in a broadcast message group. The grouping may be performed by storing the messages in a single folder representing the broadcast message group. The broadcast message and the reply messages may be indicated on the display in operation S170. Further, the transmitting communication device may select a portion of recipients in the broadcast message group to be displayed on the display and transmit a broadcast message to the portion of recipients.

Further, the transmitting communication device may display a screen to transmit unicast messages in a broadcast message group. After the broadcast message group is created and selected, the user of the transmitting communication device may selectively transmit one of another broadcast message in the broadcast message group to all recipients, a broadcast message to some of recipients in a recipient-specific group, or unicast messages. For example, if the transmitting communication device transmits a broadcast message to a recipient 1, recipient 2, and recipient 3, a broadcast message group is generated and may be displayed along with other unicast messages. If the broadcast message group is selected, the broadcast message and reply messages from the recipient 1, the recipient 2, and/or the recipient 3 may be sorted and displayed on the display. The user of the transmitting communication device may select an option to transmit another broadcast message to the recipient 1, the recipient 2, and the recipient 3 in the displayed broadcast message group. Further, the user of the transmitting communication device may select an option to transmit a broadcast message to some of the recipients, e.g., the recipient 1 and the recipient 3, in the displayed broadcast message group, or to transmit a unicast message to one recipient, e.g., the recipient 2.

Hereinafter, a scheme of indicating broadcast messages in a communication device will be described in more detail.

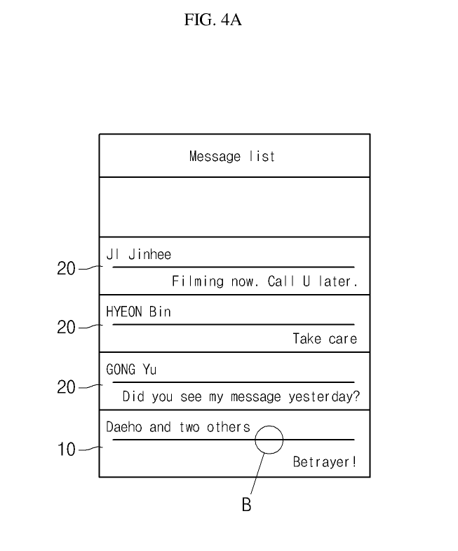

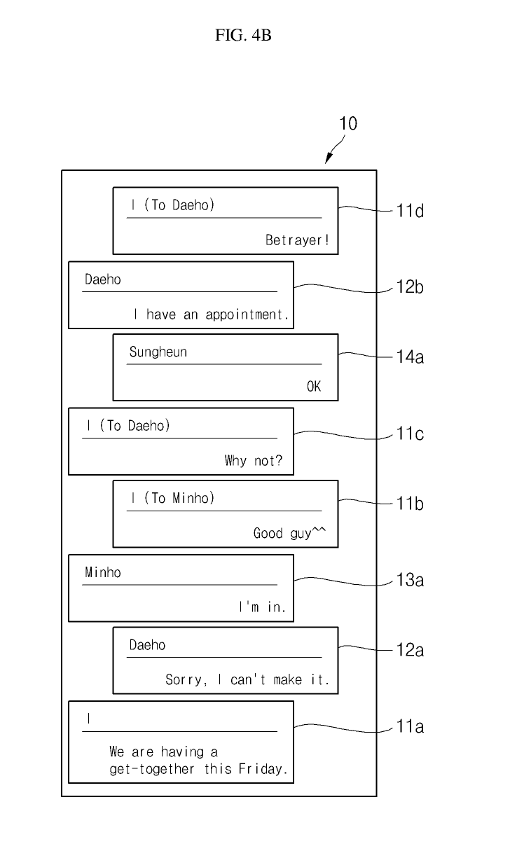

FIG. 4A is a diagram illustrating a message list including a broadcast message group displayed along with unicast messages in a communication device according to an exemplary embodiment of the present invention, and FIG. 4B is a diagram illustrating a selected broadcast message group including one or more transmitted broadcast messages and reply messages from multiple recipients according to an exemplary embodiment of the present invention. FIG. 4A and FIG. 4B will be described as if performed by communication device 100 shown in FIG. 1, but is not limited as such.

Referring to FIG. 4A, the display 120 may display a broadcast message group 10 along with unicast messages 20 in a message list. The broadcast message group 10 may representatively indicate one name of a recipient among multiple recipients of a transmitted/received broadcast message and content of the most recently transmitted or received message. The broadcast message and corresponding reply messages may not be separately displayed in the message list. The broadcast message and the reply messages may be a message thread for the broadcast message group and may be displayed if the broadcast message group 10 is selected by the user as shown in FIG. 4B.

Further, the display 120 of the communication device 100 may display a screen such that some of recipients of the broadcast message group are selected and the broadcast message may be transmitted to the selected recipients or unicast messages may be separately transmitted. For example, if the broadcast message group is selected, the user of the communication device 100 may select and transmit a broadcast message to all of the recipients in the broadcast message group (e.g., Daeho, Sungheun, and Minho), a broadcast message to some of the recipients selected from the broadcast message group (e.g., Daeho, and Minho), or a unicast message to one recipient (e.g., Daeho).

If the user of the communication device 100 selects a region B of the broadcast message group 10 from the screen shown in FIG. 4A, the broadcast message and reply messages included in the broadcast message group 10 may be displayed on the display 120 as shown in FIG. 4B. The messages may be arranged based on transmission and reception time of the messages. By displaying the broadcast message and reply messages sorted and arranged in a message thread based on time and recipients, a broadcast message sender may sequentially check the broadcast message sent by the broadcast message sender, reply text messages sent by the recipients in the broadcast message group and reply text message sent by the broadcast message sender. Messages included in the broadcast message group may be displayed as a message thread in a reverse chronological order from the last message sent/received. For example, as shown in FIG. 4B, a broadcast message 11a, reply messages received from multiple recipients including Daeho, Minho, and Sungheun 12a, 13a, 14a, and 12b, reply messages sent to the multiple recipients 11b, 11c, and 11d may be displayed in a message thread in a reverse chronological order from the last sent message 11d to the first sent message 11a. Further, if messages included in a broadcast message group are not classified into multiple message subgroups according to recipients, messages may be displayed as shown in FIG. 4B.

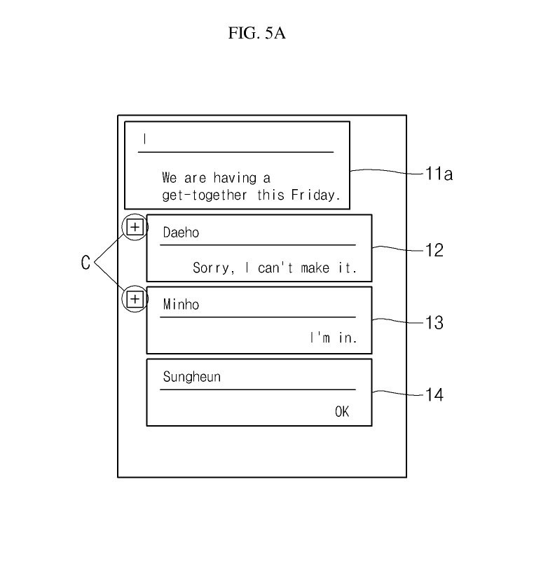

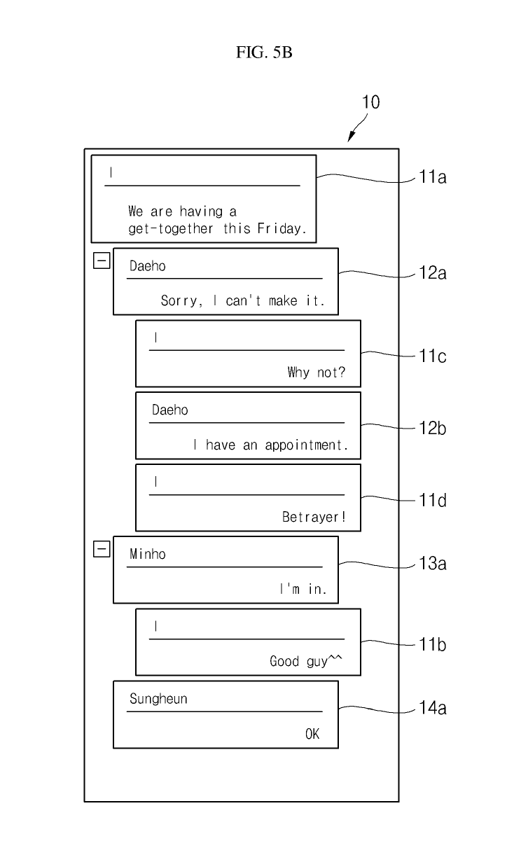

FIG. 5A is a diagram illustrating a broadcast message group including subgroups arranged by recipient in a communication device according to an exemplary embodiment of the present invention, and FIG. 5B is a diagram illustrating a broadcast message group including subgroups displaying unfolded subgroup messages according to an exemplary embodiment of the present invention.

Referring to FIG. 5A, the broadcast message group may be sub-grouped by recipient, as labeled as 12, 13 and 14, and the subgroups may be arranged. For example, the broadcast message group may include a broadcast message sent to Daeho, Minho, and Sungheun and subsequent reply messages communicated with Daeho, Minho, and Sungheun, for example. First message subgroup 12 may include a reply message sent from Daeho as a reply for the broadcast message and a message sent to Daeho in response to the reply message sent from Daeho. Similarly, Second message subgroup 13 and third message subgroup 14 may include messages communicated with Minho and Sungheun, respectively. As shown in FIG. 5A, the message subgroups 12, 13, and 14 may be recipient-specific groups classified according to recipients, but are not limited as such. Further, each of the recipient-specific groups 12, 13 and 14 may display a portion of a message received most recently by each recipient or a portion of a message received as a first reply in response to the broadcast message if the recipient-specific groups 12, 13 and 14 are in folded states (“collapsed states”) as shown in FIG. 5A. If a message subgroup includes more than one message, an unfolding icon C (“expansion icon”) may be displayed in association with the message subgroup. If the unfolding icon C is selected, messages included in a message subgroup associated with the unfolding icon C may be unfolded and displayed in a message thread as shown in FIG. 5B. If the unfolding icon C is selected again while the corresponding message subgroup is unfolded, the corresponding message subgroup may be folded back as shown in FIG. 5A.

Referring to FIG. 5B, messages included in the recipient-specific groups 12 and 13 may be displayed in a message thread if unfolding icons C associated with the recipient-specific groups 12 and 13 are selected. If the unfolding icon ‘C’ is selected, reply messages to the broadcast message 1 la, which have been transmitted and received by each of the recipients 12, 13 and 14, may be sequentially displayed in the order of transmission and reception time as shown in FIG. 5B. Accordingly, the broadcast message sender may check message threads sorted by recipients 12, 13 and 14 on a screen each at a time. If messages included in a broadcast message group are classified into multiple message subgroups by recipients, messages may be displayed to distinguish messages communicated with one recipient from messages communicated with another recipient. For example, as shown in FIG. 5A, a broadcast message 11a may be displayed on the first row of a message thread. Further, a message subgroup associated with Daeho 12, a message subgroup associated with Minho 13, and a message subgroup associated with Sungheun 14 may be displayed in the second row, the third row, and the fourth row, respectively. If a message subgroup includes more than one message, the message subgroup may display an unfolding icon C. If the unfolding icon C is selected, a sub message thread associated with the recipient may be displayed by unfolding the message subgroup. As shown in FIG. 5B, if an unfolding icon for a message subgroup associated with Daeho is selected, a first sub message thread associated with Daeho including messages 12a, 11c, 12b, and 11d may be displayed by unfolding the message subgroup associated with Daeho 12 illustrated in FIG. 5A. The messages 12a, 11c, 12b, and 11d may be displayed in a chronological order from the first reply message received from Daeho to the last message sent to Daeho. If an unfolding icon for a message subgroup associated with Minho is selected, a second sub message thread associated with Minho including messages 13a and 11b may be displayed by unfolding the message subgroup associated with Minho 13 illustrated in FIG. 5A. The messages 13a and 11b may be displayed in a chronological order from the first reply message received from Minho to the last message sent to Minho.

Hereinafter, a method of indicating a broadcast message group in a communication device will be described in more detail.

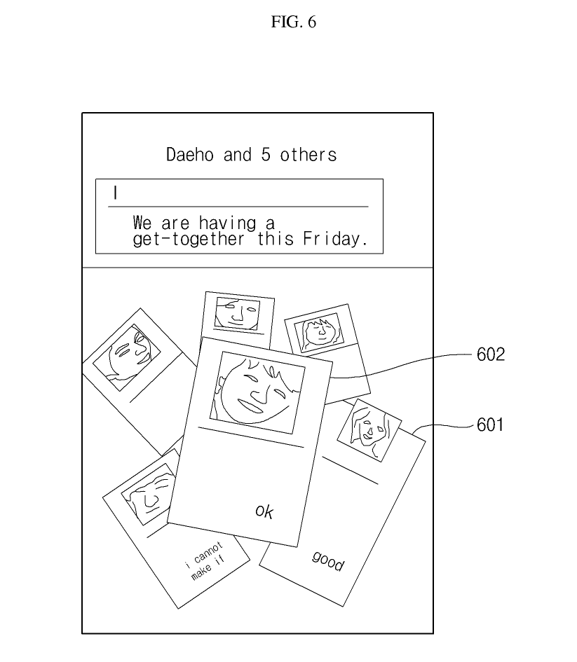

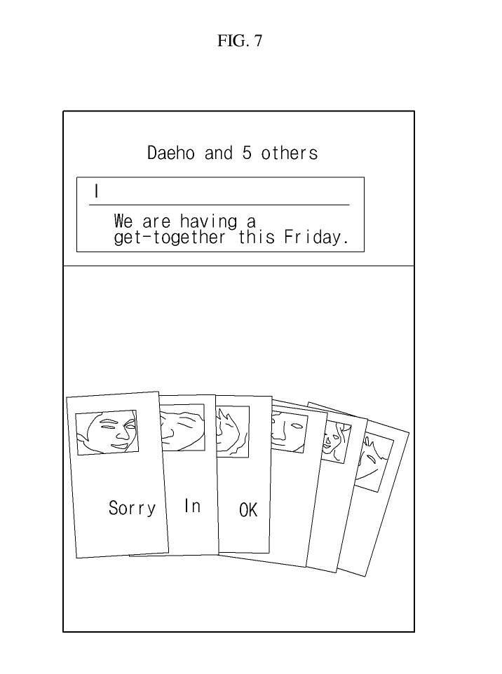

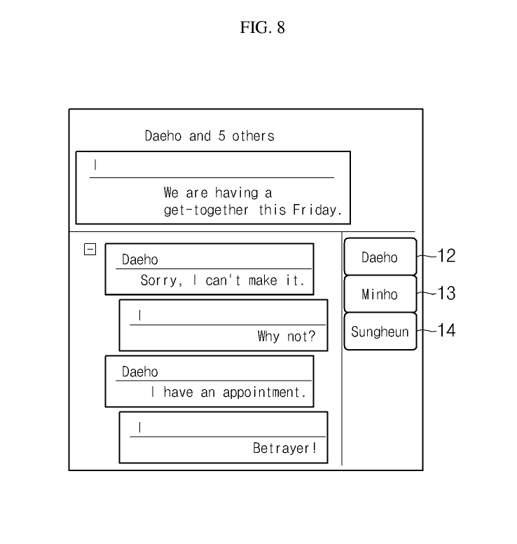

FIG. 6, FIG. 7, and FIG. 8 are diagrams illustrating a method for arranging a broadcast message group in a communication device according to an exemplary embodiment of the present invention. FIG. 6, FIG. 7, and FIG. 8 will be described as if performed by communication device 100 shown in FIG. 1, but is not limited as such.

Referring to FIG. 6, the broadcast message may be displayed at a first region of the display 120, e.g., a top portion of the display 120, and reply messages to the broadcast messages may be grouped by recipient and arranged at a second region of the display 120, e.g., a lower portion of the display 120. Each recipient-specific message group may be displayed in the form of a card image including recipient information and most recently received message content. For example, photograph images of recipients and content of the most recently received reply message for each group may be representatively indicated on the card image.

Further, the card images of the recipient-specific message groups may be randomly located on the second region of the display 120. Further, the visual location of the card images may be determined based on message receiving time of a message for each specific message group. For example, if the most recently received message from recipient 1 is received earlier than the most recently received message from recipient 2, the card image 602 for recipient 2 may be displayed on an upper layer than the layer of the card image 601 for recipient 1. Therefore, the broadcast message sender may verify the reception sequence of the messages based on the arranged position.

Further, the card images or the messages may be distinctly displayed by varying color, chroma or brightness. For example, the more recently the messages are received, the more distinctly the messages may be displayed by changing color and/or increasing chroma levels. If the reception time is earlier, the messages may be displayed less distinctly by changing color and/or decreasing chroma levels.

Referring to FIG. 7, a broadcast message group may be arranged in a manner similar to that shown in FIG. 6. However, each of reply message groups by recipient may be displayed in the form of spreading a deck of cards. Therefore, the user may recognize the order of message receipts by the reply message groups based on the arranged order of the card images. Further, if a card image for a recipient is selected, messages transmitted to and received from the recipient may be displayed on the display 120.

Referring to FIG. 8, reply messages responding to the broadcast message may be grouped by recipients 12, 13 and 14. Further, tabs for selecting each message subgroup may be displayed. For example, tabs indicating names of the recipients 12, 13 and 14 may be displayed on the display 120. The sender may select a tab and check reply messages received from a selected recipient among the recipients 12, 13 and 14 and reply messages sent to the selected recipient among the recipients 12, 13 and 14.

As described above, the communication device 100 according to the present invention may group the broadcast message and the reply messages associated with the broadcast message and display the broadcast message group together with other unicast message, thereby facilitating message search with increased visibility. The broadcast message group may be selected and displayed in the order of messages received. The broadcast message group may be grouped by recipients, and messages communicated with each recipient may be separately checked, thereby increasing user's convenience. The messages may be text messages, e-mails, and the like.

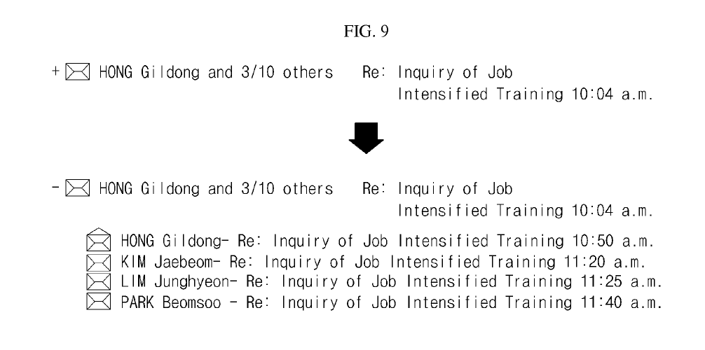

FIG. 9 is a diagram illustrating broadcast electronic mails grouped and arranged by recipients in a communication device according to an exemplary embodiment of the present invention.

Referring to FIG. 9, e-mails may be grouped and displayed on a display of a communication device. Exemplary embodiments with respect to text messages described above may be applied to group and display e-mails. A broadcast e-mail and reply e-mails associated with the broadcast e-mail may be grouped and displayed together.

Thus, the reply e-mails and corresponding broadcast message-mail may be grouped in the same manner as the reply messages and the broadcast messages described above, thereby allowing a user to recognize the broadcast mail group from the e-mails including other unicast e-mails. In addition, the broadcast e-mail and associated reply e-mails in each broadcast mail group may be arranged by recipients or arranged in the order of receiving time.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to manage a broadcast message group, comprising:
a storage unit to store a broadcast message and multiple messages associated with the broadcast message;
a display unit to display the broadcast message and multiple message subgroups; and
a controller to classify the multiple messages into the multiple message subgroups, and to generate the broadcast message group comprising the broadcast message and the multiple message subgroups.

2. The apparatus of claim 1, wherein the multiple messages are classified according to recipients of the broadcast message.

3. The apparatus of claim 1, wherein the multiple message subgroups are displayed in different layers according to time information of messages included in the multiple message subgroups.

4. The apparatus of claim 1, wherein the multiple message subgroups comprise recipient information and content of a message.

5. The apparatus of claim 1, wherein the display unit displays a message thread of a message subgroup among the multiple message subgroups if the message subgroup is selected.

6. The apparatus of claim 1, wherein the display unit displays a selection tab for selecting a message subgroup among the multiple message subgroups, and displays a message thread of a message subgroup corresponding to the selection tab if the selection tab is selected.

7. The apparatus of claim 1, wherein the display unit displays an unfolding icon corresponding to a message subgroup among the multiple message subgroups, and
the display unit displays a message thread in association with the message subgroup if the unfolding icon is selected.

8. The apparatus of claim 7, wherein the message thread comprises classified messages arranged according to time information of the classified messages.

9. The apparatus of claim 1, wherein the display unit displays a broadcast reply icon for generating a broadcast reply message in response to the broadcast message, the broadcast reply message is configured to be transmitted to recipients of the broadcast message.

10. A method for managing a broadcast message group, comprising:
storing a broadcast message and multiple messages associated with the broadcast message;
classifying the multiple messages into multiple message subgroups;
generating the broadcast message group comprising the broadcast message and the multiple message subgroups; and
displaying the broadcast message and the multiple message subgroups if the broadcast message group is selected.

11. The method of claim 10, wherein the multiple messages are classified according to recipients of the broadcast message.

12. The method of claim 10, wherein the multiple message subgroups are displayed in different layers according to time information of messages included in the multiple message subgroups.

13. The method of claim 10, wherein the multiple message subgroups comprise recipient information and content of a message.

14. The method of claim 10, further comprising: displaying a message thread of a message subgroup among the multiple message subgroups if the message subgroup is selected.

15. The method of claim 10, further comprising:
displaying a selection tab for selecting a message subgroup among the multiple message subgroups; and
displaying a message thread of a message subgroup corresponding to the selection tab if the selection tab is selected.

16. The method of claim 10, further comprising:
displaying an unfolding icon corresponding to a message subgroup among the multiple message subgroups; and
displaying a message thread in association with the message subgroup if the unfolding icon is selected.

17. The method of claim 16, wherein the message thread comprises classified messages arranged according to time information of the classified messages.

18. An apparatus, comprising:
a storage unit to store a broadcast message and a reply message associated with the broadcast message;
a display unit to display a broadcast message group in a message list;
a controller to generate the broadcast message group comprising the broadcast message and the reply message,
wherein the display unit displays the broadcast message and the reply message if the broadcast message is selected.

19. The apparatus of claim 18, wherein the message list comprises a unicast message group comprising a message sent to one recipient and a reply message received from the recipient.

20. The apparatus of claim 18, wherein the display unit further displays multiple messages associated with the broadcast message according to time information of the multiple messages.

21. The apparatus of claim 18, wherein the display unit displays multiple message subgroups associated with the broadcast message, the multiple message subgroups being classified according to recipients of the broadcast message.
